(19) United States
(12) Patent Application Publication
(10) Pub. No.: US 2025/0303982 A1
(43) Pub. Date: Oct. 2, 2025

(54) WIRING MODULE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Yuta TOME, Osaka (JP); Housei MIZUNO, Osaka (JP); Takeshi KOIDE, Osaka (JP); Yoshitaka KURODA, Osaka (JP); Mikihiro JINNO, Osaka (JP); Megumi ISHIDA, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/868,953

(22) PCT Filed: May 24, 2023
(86) PCT No.: PCT/JP2023/019305

§ 371 Date: Nov. 25, 2024

(30) Foreign Application Priority Data
Jun. 2, 2022 (JP) 2022-090394

(51) Int. Cl. B60R 16/02

(52) U.S. Cl. CPC B60R 16/0215

(57) ABSTRACT

A wiring module includes: a wiring member including a first section, a second section, and a third section as sections different from each other along an extension direction; a first rigid member attached to the first section; and a second rigid member attached to the second section. A portion including the first section and the first rigid member is a first portion, a portion including the second section and the second rigid member is a second portion, and a portion including the third section is a third portion. The third portion has bendability to be able to be folded. The second section is more bendable than the first portion, and is less bendable than the third portion.

### TECHNICAL FIELD

The present disclosure relates to a wiring module.

### BACKGROUND ART

Patent Document 1 discloses an electrical component-equipped wire harness in which an electrical component, a floor silencer, and a wire harness are integrally formed to be easily assembled to a vehicle.

### PRIOR ART DOCUMENTS

### Patent Document(s)

Patent Document 1: Japanese Patent Application Laid-Open No. 2019-41458

### SUMMARY

### Problem to be Solved by the Invention

It is desired that when a wiring module is assembled to a vehicle, for example, the wiring module is easily transported into a position where an assembly operation is performed and is easily disposed along a predetermined route for an assembly target after the transportation.

Accordingly, an object is to provide a technique capable of easily transporting a wiring module and positioning the wiring module along a predetermined route.

### Means to Solve the Problem

A wiring module according to the present disclosure is a wiring module including: a wiring member including a first section, a second section, and a third section as sections different from each other along an extension direction; a first rigid member attached to the first section; and a second rigid member attached to the second section, wherein a portion including the first section and the first rigid member is a first portion, a portion including the second section and the second rigid member is a second portion, a portion including the third section is a third portion, the first portion, the second portion, and the third portion are portions different from each other, the third section includes a section located between the first section and the second section, the third portion has bendability to be able to be folded, the first rigid member has rigidity larger than the second rigid member, and the second portion is more bendable than the first portion, and is less bendable than the third portion.

### Effects of the Invention

According to the present disclosure, the wiring module can be easily transported and disposed along a predetermined route.

### BRIEF DESCRIPTION OF DRAWINGS

FIG. 1 is a schematic perspective view illustrating a vehicle in which a wiring module is disposed and a route of a wiring member in the vehicle.

FIG. 2 is a plan view illustrating a wiring module according to an embodiment 1.

FIG. 3 is a cross-sectional view along a III-III line in FIG. 2.

FIG. 4 is a cross-sectional view along a IV-IV line in FIG. 2.

FIG. 5 is a cross-sectional view along a V-V line in FIG. 2.

FIG. 6 is a schematic view explaining a difference of bendability between a first portion, a second portion, and a third portion.

FIG. 7 is a diagram explaining attachment of the second portion.

FIG. 8 is a diagram illustrating a state where the wiring module is folded.

FIG. 9 is a plan view illustrating a wiring module according to an embodiment 2.

FIG. 10 is a cross-sectional view along an X-X line in FIG. 9.

FIG. 11 is a diagram illustrating a state where the wiring module is folded.

FIG. 12 is a plan view illustrating a modification example of the wiring module according to the embodiment 2.

FIG. 13 is a cross-sectional view along a XIII-XIII line in FIG. 12.

### DESCRIPTION OF EMBODIMENT(S)

### Description of Embodiments of Present Disclosure

Embodiments of the present disclosure are listed and described firstly.

A wiring module according to the present disclosure is as follows.
(1) A wiring module includes: a wiring member including a first section, a second section, and a third section as sections different from each other along an extension direction; a first rigid member attached to the first section; and a second rigid member attached to the second section, wherein a portion including the first section and the first rigid member is a first portion, a portion including the second section and the second rigid member is a second portion, a portion including the third section is a third portion, the first portion, the second portion, and the third portion are portions different from each other, the third section includes a section located between the first section and the second section, the third portion has bendability to be able to be folded, the first rigid member has rigidity larger than the second rigid member, and the second portion is more bendable than the first portion, and is less bendable than the third portion.
(1) According to the wiring module, the wiring module can be folded so that the first portion and the second portion each provided with the rigid member are overlapped with each other when the wiring module is folded at a part of the third portion located between the first section and the second section. The first portion is less bendable than the second portion and the third portion, thus when the first portion in the folded wiring module is grasped and transported, the wiring module hardly bows and is easily transported. When the second portion is unfolded while the first portion is disposed in a predetermined position in the folded wiring module after transportation, the second portion is easily unfolded by reason that the second rigid member is provided to the second portion. The second portion is more bendable than the first portion, thus a part of the second portion after unfolding deviated from a predetermined route is easily deformed along the predetermined route. According to such configurations, the wiring module can be easily transported and disposed along the predetermined route.
(2) In the wiring module according to (1), it is applicable that the first section includes a section disposed on a floor of a vehicle, the second section includes a section disposed along a pillar of the vehicle, and the third section includes a section disposed along a wheel house of the vehicle. Accordingly, the wiring module disposed on the floor of the vehicle and a section adjacent to the floor can be easily transported and disposed along a predetermined route.
(3) The wiring module according to (2) includes a silencer covering the floor of the vehicle, and the silencer includes a wiring arrangement part in which the first section is disposed to be the first rigid member and a body part continuously formed with the wiring arrangement part and more flexible than the wiring arrangement part. Accordingly, the silencer can supply rigidity to the first section while the silencer and the wiring member are integrally formed.
(4) In the wiring module according to (3), it is applicable that the silencer can be folded along a fold line provided to the body part before being attached to the vehicle, and when the silencer is folded at the third portion, the second portion located on an outer side of the silencer can be surrounded by the silencer which has been folded. The silencer can be folded, thus the wiring module is compactible, and can be easily put into the vehicle from a side opening part for a side door or a rear opening part in the vehicle. The portion located on the outer side of the silencer is folded at the third portion, and can be surrounded by the folded silencer, thus it is suppressed that the wiring member hangs down and is caught on a surrounding component when the wiring module is transported, and the wiring module is easily transported.
(5) In the wiring module according to (4), it is applicable that the fold line is provided to extend in a right-left direction of the vehicle in an intermediate part along a front-back direction of the vehicle, the third portion is provided in a position of the fold line, and the first portion is provided to a front side and a back side of the vehicle across the fold line. Accordingly, the silencer can be easily transported into the vehicle from the side opening part for the side door of the vehicle so that a right-left direction of the silencer coincides with a right-left direction of the vehicle. Accordingly, the silencer after transportation can be easily positioned on the floor.
(6) In the wiring module according to (4), the fold line may be provided to extend in a front-back direction of the vehicle in an intermediate part of the vehicle along a right-left direction. Accordingly, the first portion can be continuously provided easily without disconnection from a front end to a back end of the silencer in the front-back direction of the vehicle.
(7) In the wiring member according to any one of (1) to (6), the second rigid member may be a sheet material made of resin. Accordingly, the second rigid member can be simply formed.
(8) In the wiring module according to any one of (1) to (7), it is applicable that the wiring member includes a plurality of wire-like transmission members, the third portion includes an adhesive tape banding the plurality of wire-like transmission members, and the second rigid member has higher rigidity than the adhesive tape. Accordingly, the adhesive tape protects the third section of the wiring member. The second rigid member having higher rigidity than the adhesive tape protects the second section of the wiring member.

### Detailed Description of Embodiment of Present Disclosure

Specific examples of a wiring module of the present disclosure are described hereinafter with reference to the drawings. The present disclosure is not limited to these examples, but is indicated by claims, and it is intended that meanings equivalent to claims and all modifications within a scope of claims are included.

### Embodiment 1

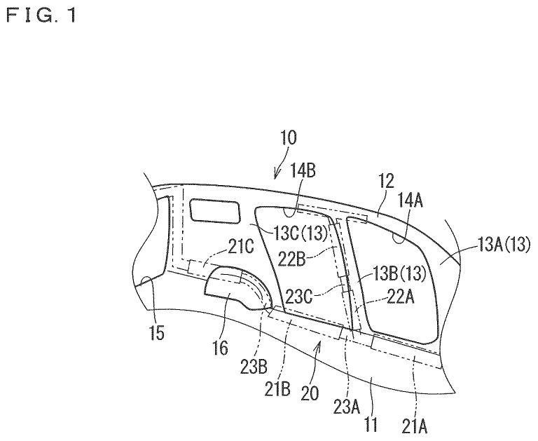

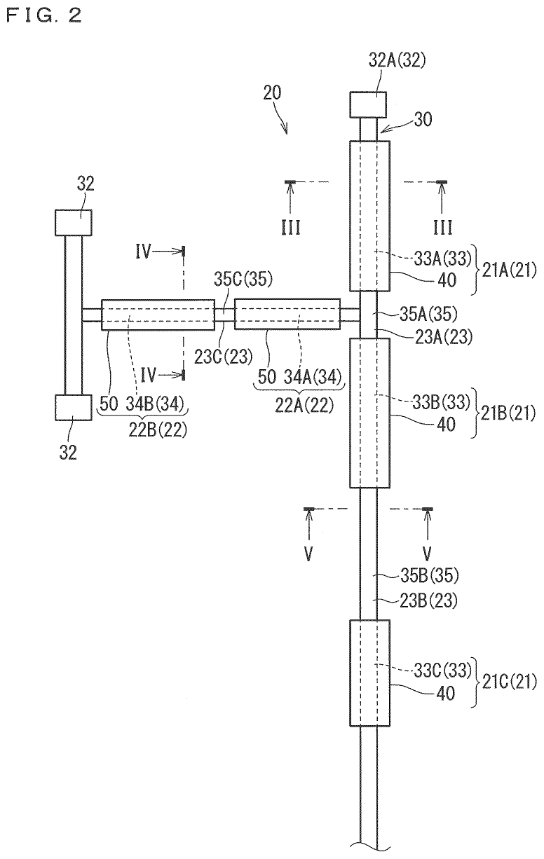

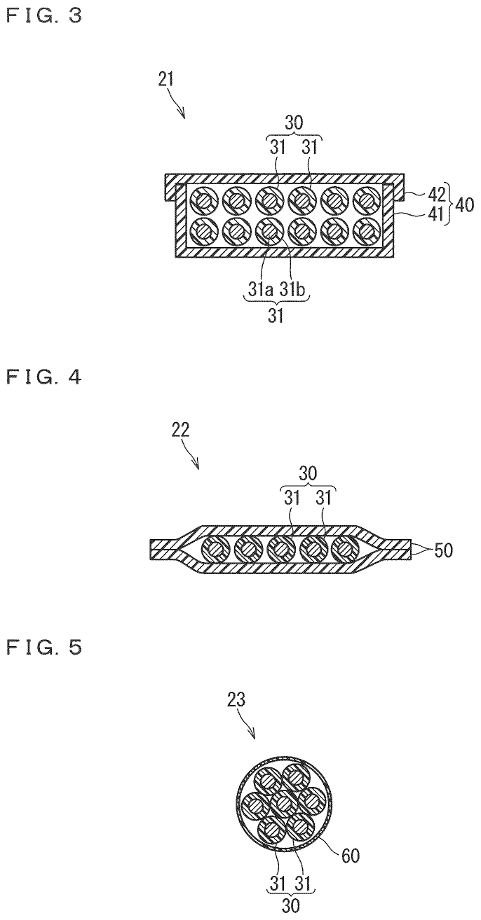

A wiring module according to an embodiment 1 is described hereinafter. FIG. 1 is a schematic perspective view illustrating a vehicle 10 in which a wiring module 20 is disposed and a route of a wiring member 30 in the vehicle 10. FIG. 2 is a plan view illustrating the wiring module 20 according to the embodiment 1. FIG. 3 is a cross-sectional view along a III-III line in FIG. 2. FIG. 4 is a cross-sectional view along a IV-IV line in FIG. 2. FIG. 5 is a cross-sectional view along a V-V line in FIG. 2.

The wiring module 20 includes the wiring member 30, a first rigid member 40, and a second rigid member 50. The first rigid member 40 and the second rigid member 50 are attached to different positions different from each other in the wiring member 30. The wiring module 20 is disposed along a predetermined route in the vehicle 10. In the description of the present embodiment, the wiring module 20 is disposed on a floor 11 of the vehicle 10 and a surrounding region thereof.

The vehicle 10 in which the wiring module 20 is disposed is described firstly. The vehicle 10 includes the floor 11, a roof 12, and a pillar 13. The floor 11 and the roof 12 are separated from each other in a height direction of the vehicle 10. The floor 11 extends to a lower side of a vehicle interior. The roof 12 extends to an upper side of the vehicle interior. The pillar 13 extends in a height direction in an outer edge of the vehicle 10 along the right-left direction to connect the floor 11 and the roof 12. Illustrated in FIG. 1 is an example of only a side edge portion of the roof 12, and the other part of the roof 12 is omitted.

Illustrated in FIG. 1 is an example of the vehicle 10 including an A pillar 13A, a B pillar 13B, and a C pillar 13C as the pillar 13 is illustrated. When a passenger seat located in a forefront of the vehicle 10 is a first seat, the A pillar 13A is provided in front of the first seat. When a passenger seat next to the first seat in the front-back direction of the vehicle is a second seat, the B pillar 13B is provided between the first seat and the second seat, and the C pillar 13C is provided to a back side of the second seat.

Provided to the vehicle 10 is a side opening part 14A for a passenger of the first seat to get in and out of the vehicle 10 and a side opening part 14B for a passenger of the second seat to get in and out of the vehicle 10. The side opening part 14B is an opening part surrounded by the floor 11, the roof 12, the A pillar 13A and the B pillar 13B. The side opening part 14B is an opening part surrounded by the floor 11, the roof 12, the B pillar 13B and the C pillar 13C. A side door not shown in the diagrams is openably and closably attached to the side opening part 14A and the side opening part 14B.

A rear opening part 15 and a wheel house 16 are provided to the vehicle 10. A rear glass or a rear door, for example, not shown in the diagrams is attached to the rear opening part 15. A width of the rear opening part 15 is normally larger than that of each of the side opening parts 14A and 14B. The wheel house 16 is a part for housing a vehicle wheel. Illustrated as the wheel house 16 in FIG. 1 is an example of the wheel house 16 for housing a rear wheel. The wheel house 16 is provided to a back side of the side opening part 14B.

In the present example, the wiring module 20 includes a part disposed along the floor 11, a part disposed along the B pillar 13B, and a part disposed along the wheel house 16. A part where the wiring module 20 is disposed is curved in the B pillar 13B and the wheel house 16. The wiring module 20 is disposed to have a curved shape so as to extend along the curved part of the B pillar 13B and the wheel house 16.

The wiring member 30 according to the present embodiment is also referred to as a floor harness, and is disposed on the floor 11 and a surrounding region thereof. The wiring member 30 is branched, and extends from a battery and an ECU disposed on a front side of the vehicle 10 toward each apparatus disposed on a back side of the vehicle 10, for example. The wiring member 30 includes a plurality of wire-like transmission members 31. The plurality of wire-like transmission members 31 connect components in the vehicle 10. The wire-like transmission member 31 transmits electrical power or light. The wire-like transmission member 31 includes a transmission wire body and a covering for covering the transmission wire body. In the description herein, the wire-like transmission member 31 is a covering electrical wire including a conductor core wire 31a and a covering 31b. The wire-like transmission member 31 may be an optical fiber cable. A connector 32, for example, is provided to an end portion of the wire-like transmission member 31.

The wiring member 30 includes a first section 33, a second section 34, and a third section 35. The first section 33, the second section 34, and the third section 35 are sections different from each other along an extension direction. The first rigid member 40 is attached to the first section 33. The first section 33 is a section to which the first rigid member 40 is attached. In the present embodiment, the first section 33 includes a section disposed on the floor 11 of the vehicle 10. The second rigid member 50 is attached to the second section 34. The second section 34 is a section to which the second rigid member 50 is attached. In the present embodiment, the second section 34 includes a section disposed along the pillar 13 of the vehicle 10. Any of the first rigid member 40 and the second rigid member 50 is not attached to the third section 35. The third section 35 includes a section located between the first section 33 and the second section 34. Furthermore, in the present embodiment, the third section 35 includes a section located between two first sections 33, a section located between two second sections 34, and a section located between two first sections 33 to be disposed along the wheel house 16 of the vehicle 10.

In the wiring module 20, a portion including the first section 33 and the first rigid member 40 is a first portion 21, a portion including the second section 34 and the second rigid member 50 is a second portion 22, and a portion including the third section 35 is a third portion 23. The first portion 21, the second portion 22, and the third portion 23 are portions different from each other in the wiring module 20. The third portion 23 has bendability to be able to be folded. The second portion 22 is more bendable than the first portion 21, and is less bendable than the third portion 23.

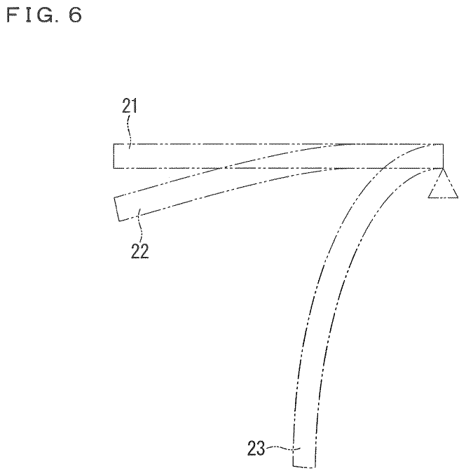

A difference of the bendability is described more specifically with reference to FIG. 6. FIG. 6 is a diagram explaining the difference of bendability between the first portion 21, the second portion 22, and the third portion 23.

FIG. 6 illustrates the first portion 21, the second portion 22, and the third portion 23 whose one ends are supported. A degree of hanging of the other ends of the first portion 21, the second portion 22, and the third portion 23 is different from each other. The third portion 23 is curved near a support position, and the other end hangs down with a large degree. The first portion 21 and the second portion 22 are not curved. The first portion 21 is kept in a straight form, and the second portion 22 bows. Both the first portion 21 and the second portion 22 may be kept in a straight shape. In this case, it is sufficient that when the other ends of the first portion 21 and the second portion 22 are pressed, the second portion 22 bows with smaller force than the first portion 21. Both the first portion 21 and the second portion 22 may bow. In this case, it is sufficient that the second portion 22 bows with a larger degree than the first portion 21.

Rigidity of the first rigid member 40 is larger than that of the second rigid member 50. For example, the first rigid member 40 has rigidity so as to be able to keep a straight shape even when a weight of the wire-like transmission member 31 is applied thereto. In the present embodiment, a protector 40 is provided as the first rigid member 40. The protector 40 includes a protector body 41 and a cover 42. The protector body 41 includes a bottom plate and a side plate, and a part thereof surrounded by the bottom plate and the side plate is formed into a groove-like shape. The wire-like transmission member 31 is housed in the groove. The cover 42 covers an upper opening of the groove.

Rigidity of the second rigid member 50 is smaller than that of the first rigid member 40. For example, the second rigid member 50 has rigidity so as to be able to keep a straight shape when no external force is applied, and has plasticity so as to be able to bow when the second rigid member 50 is pressed. The second rigid member 50 may have rigidity so as to be able to keep a straight shape even when a weight of the wire-like transmission member 31 is applied, or may also have rigidity small enough to bow when the weight of the wire-like transmission member 31 is applied. It is sufficient that the second rigid member 50 has rigidity so as not to be curved by the weight of the wire-like transmission member 31.

In the present embodiment, the second rigid member 50 is a sheet material 50 made of resin. The resin is polyoxymethylene (POM) resin, for example. In the example illustrated in FIG. 4, two sheet materials 50 sandwich the wire-like transmission member 31, however, the wire-like transmission member 31 may be attached to one sheet material 50. The second rigid member 50 may be a member other than the sheet material 50 made of resin. For example, the second rigid member may be a thin metal sheet. For example, the second rigid member may be a tube-like member.

In the present embodiment, the third portion 23 includes an adhesive tape 60 banding the plurality of wire-like transmission members 31. The third portion 23 can be bended together with the adhesive tape 60. The second rigid member 50 has higher rigidity than the adhesive tape 60. However, the third portion 23 may not include the adhesive tape 60. The plurality of wire-like transmission members 31 may be banded by another banding member different from the adhesive tape 60. The banding member may be a flexible resin sheet of or a banding band, for example. The third portion 23 may include a portion where an exterior member is not provided and the plurality of wire-like transmission members 31 are exposed.

The first section 33, the second section 34, and the third section 35 include intermediate sections which are not the end portions of the wiring member 30, respectively. The end portion of the wiring member 30 may have flexibility similar to the third portion 23 so as to be bended in connection to the connector 32. The end portion of the wiring member 30 may be integrally formed with the first rigid member 40 or the second rigid member 50 and regulated so as not to be bended. In this case, the connector 32 provided to the end portion may be a standby connector.

In the present embodiment, the plurality of (three herein) first sections 33 are provided. Three first sections 33 are referred to as first sections 33A, 33B, and 33C in order from the front side to the back side along the front-back direction of the vehicle 10 in some cases. The first sections 33A and 33B are disposed in front of the wheel house 16, and the first section 33C is disposed in back of the wheel house 16 in the floor 11. Portions of the first portion 21 corresponding to the first sections 33A, 33B, and 33C are referred to as first portions 21A, 21B, and 21C, respectively.

In the present embodiment, the plurality of (two herein) second sections 34 are provided. Two second sections 34 are referred to as second sections 34A and 34B in order from a lower side to an upper side along the height direction of the vehicle 10 in some cases. Portions of the second portion 22 corresponding to the second sections 34A and 34B are referred to as second portions 22A and 22B, respectively.

In the present embodiment, the plurality of (three herein) third sections 35 are provided. A third section 35A in three third sections 35 is a section between the first section 33A and the second section 34A. A branch part is located in the third section 35A, and the third section 35A also includes a section between the first section 33A and the first section 33B. A third section 35B is a section between the first section 33B and the first section 33C, and is a section disposed along the wheel house 16. A third section 35C is a section between the second section 34A and the second section 34B, and is a section disposed along the B pillar 13B. Portions of the third portion 23 corresponding to the third sections 35A, 35B, and 35C are referred to as third portions 23A, 23B, and 23C, respectively.

A section on a back side of the first section 33C and a section on an upper side of the second section 34B may be the first section, the second section, or the third section.

The third section 35 includes a bending route section. The bending route section is a section disposed to be bended along a bending route in the vehicle 10. The third portion 23 is easily bended, thus is also easily bended to extend along the bending route section. Herein, the third section 35B is a bending route section disposed to be bended along the wheel house 16. Herein, the third section 35A is the bending route section disposed to be bended from the floor 11 toward the B pillar 13B.

The third section 35 may include a folding section. The folding section is a section disposed straight in the vehicle 10, but is easily bended to be folded in transportation of the wiring module 20. For example, a section in the third section 35A between the first section 33A and the first section 33B may be the folding section.

A route of the first section 33A and the second section 34 has a shape closer to a straight shape than a route of the bending route section. Herein, the route of the first section 33 has a shape closer to a straight shape than a route of the second section 34. The route of the first section 33 is a straight route herein.

The first section 33 and the second section 34 are longer than the third section between the first section 33A and the second section 34. The first section 33 and the second section 34 have a certain degree of length (for example, a length equal to or larger 100 mm, 200 mm, or 300 mm) and are continuously formed.

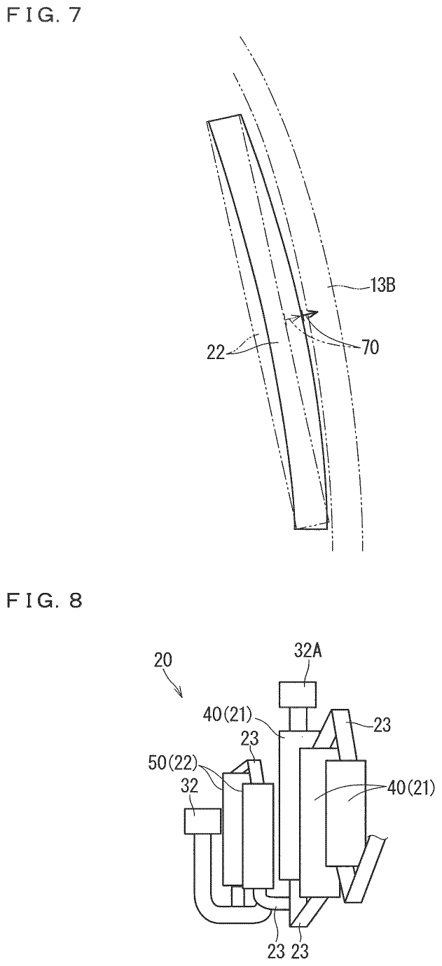

The second portion 22 includes a portion bended and disposed. The second portion 22 is disposed along the pillar 13 (a part having a large curvature radius) which is gently curved. The second portion 22 has plasticity so as to be bendable together with the second rigid member 50. Attachment of the second portion 22 is described more specifically with reference to FIG. 7. FIG. 7 is a diagram explaining the attachment of the second portion 22.

As shown by a virtual line in FIG. 7, the second portion 22 is roughly disposed in the B pillar 13B as an arrangement position while keeping the straight shape to some extent. In this state, a fixing member 70 provided to the second portion 22 is away from the B pillar 13B. When the fixing member 70 is moved to the B pillar 13B for fixation, as shown by a solid line in FIG. 7, the second portion 22 bows, and the fixing member 70 is fixed to the B pillar 13B, thus the second portion 22 is held in a bowing state. Accordingly, the second portion 22 is disposed to have the curved shape along the curved B pillar 13B.

It is also applicable that a part where the second portion 22 is disposed curvedly extends to constitute a cylindrical member made of metal and having large rigidity, and the second portion 22 is disposed to be passed through an inner part of the cylindrical shape. In this case, the second portion 22 slides along an inner surface of the cylindrical member when the second portion 22 is passed through the inner part of the cylindrical member. At this time, the second portion 22 bows upon receiving force from the inner surface of the cylindrical member, and is located in the inner part of the cylindrical member as it is, thereby being disposed to have a curved shape along the curved cylindrical member.

The third portion 23 includes a portion bended and disposed. The third portion 23 is bended with a larger degree than the second portion 22. The third portion 23 has bendability. The third portion 23 is disposed along the wheel house 16 (a part having a small curvature radius) which is curved more sharply than the pillar 13.

FIG. 8 is a diagram illustrating a state where the wiring module 20 is folded.

The wiring module 20 is bended at the third portion 23, thereby being folded. At this time, as illustrated in FIG. 8, it is sufficient that the wiring module 20 has a configuration that the first portion 21 and the second portion 22 are folded to be overlapped with each other while extending in parallel to each other. In the wiring module 20, the end portion of the wiring member 30, for example, may be temporarily fixed to the first portion 21 by the adhesive tape 60, for example.

When the first portion 21 in the folded wiring module 20 is grasped and transported, hanging of a part extending from a grasp position can be suppressed. In the wiring member 30, a section from the connector 32A on the front side of the vehicle 10 to the branch part on a lower side of the B pillar 13B is a section in which the number of the wire-like transmission members 31 and a weight are largest. In the present embodiment, the first rigid member 40 is provided to the section. Accordingly, the section is supported by the first rigid member 40 when the section is grasped while the wiring module 20 is folded, thus the wiring module 20 is easily grasped.

The folded wiring module 20 is transported onto the floor 11 in the inner part of the vehicle 10 through the side opening part 14A, the side opening part 14B, or the rear opening part 15. The folded wiring module 20 is unfolded on the floor 11, and each portion is disposed along a predetermined route. At this time, the wiring module 20 can be unfolded while the first portion 21 and the second portion 22 are kept in the straight shape, thus can be easily unfolded.

### Effect etc.

According to the wiring module 20 having the above configuration, the wiring module 20 can be folded so that the first portion 21 and the second portion 22 each provided with the rigid member are overlapped with each other when the wiring module 20 is folded at a part of the third portion 23 located between the first section 33 and the second section 34. The first portion 21 is less bendable than the second portion 22 and the third portion 23, thus when the first portion 21 in the folded wiring module 20 is grasped and transported, the wiring module 20 hardly bows and is easily transported. When the second portion 22 is unfolded while the first portion 21 in the folded wiring module 20 after the transportation is disposed in a predetermined position, the second rigid member 50 is provided to the second portion 22, thus the second portion 22 is easily unfolded. The second portion 22 is more bendable than the first portion 21, thus a part of the second portion 22 after unfolding deviated from a predetermined route is easily deformed along the predetermined route. According to such configurations, the wiring module 20 can be easily transported and disposed along the predetermined route.

The first section 33 includes a section disposed on the floor 11 of the vehicle 10, the second section 34 includes a section disposed along the pillar 13 of the vehicle 10, and the third section 35 includes a section disposed along the wheel house 16 of the vehicle 10. Accordingly, the wiring module 20 disposed on the floor 11 of the vehicle 10 and a section adjacent to the floor 11 can be easily transported and disposed along a predetermined route.

The second rigid member 50 is a sheet material 50 made of resin. Accordingly, the second rigid member 50 can be simply formed.

The wiring member 30 includes the plurality of wire-like transmission members 31, the third portion 23 includes the adhesive tape 60 banding the plurality of wire-like transmission members 31, and the second rigid member 50 has higher rigidity than the adhesive tape 60. Accordingly, the adhesive tape 60 protects the third section 35 of the wiring member 30. The second rigid member 50 having higher rigidity than the adhesive tape 60 protects the second section 34 of the wiring member 30.

### Embodiment 2

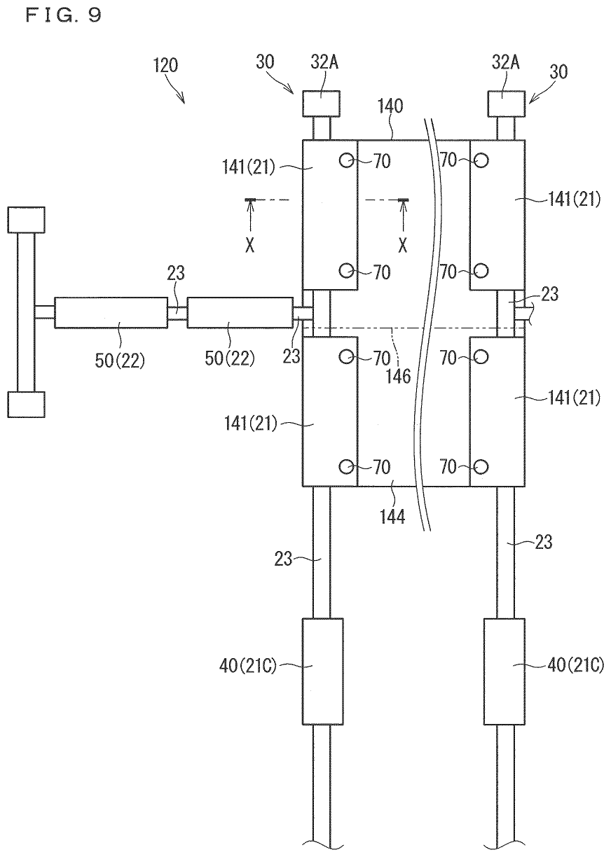

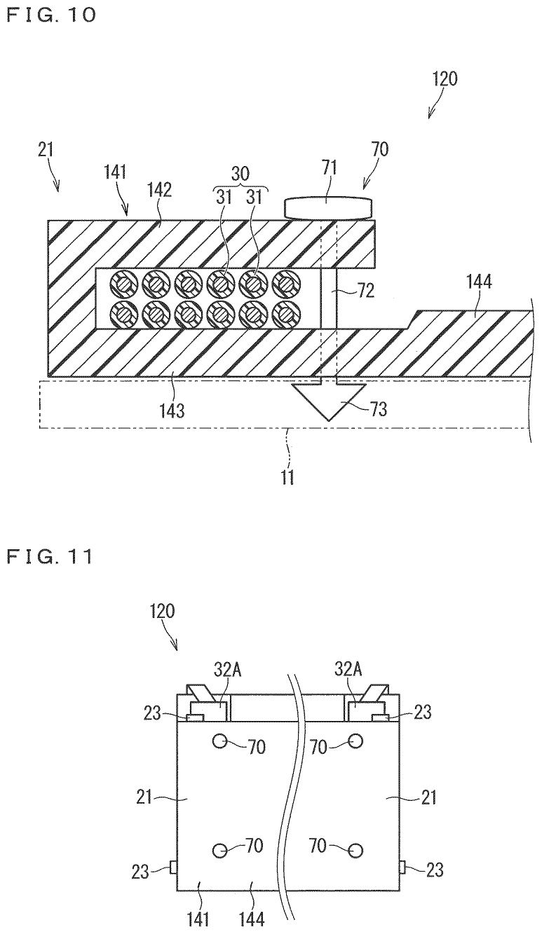

A wiring module according to an embodiment 2 is described. FIG. 9 is a plan view illustrating a wiring module 120 according to the embodiment 2. FIG. 10 is a cross-sectional view along an X-X line in FIG. 9. FIG. 11 is a diagram illustrating a state where the wiring module 120 is folded. In the following description, the same reference numerals are assigned to the similar constituent elements described above, and the description thereof will be omitted.

The wiring module 120 according to the present embodiment is different from the wiring module 20 described above in that the wiring module 120 includes a silencer 140 in place of the protector 40. The silencer 140 covers the floor 11 of the vehicle 10. In the wiring module 120 according to the present embodiment, a part of the silencer 140 serves as a first rigid member 141. The silencer 140 may be a member including numberless fibers. The silencer 140 may be a non-woven cloth or a felt. The silencer 140 may be foam resin, for example.

The silencer 140 includes a wiring arrangement part 141 and a body part 144. The wiring arrangement part 141 is a part in which the first section 33 is disposed to be the first rigid member 141. The body part 144 is a part continuously formed with the wiring arrangement part 141 and more flexible than the wiring arrangement part 141. The wiring arrangement part 141 and the body part 144 may be formed of the same material. It is applicable that a part of a base material having uniform rigidity is thermally pressed so that the wiring arrangement part 141 has larger rigidity than the body part 144. It is also applicable that a base member includes parts each having a thickness different from each other and the part having a larger thickness has larger rigidity than the part having a smaller thickness.

The wiring arrangement part 141 according to the present embodiment includes two sandwiching pieces 142 and 143 sandwiching the wiring member 30 in the up-down direction. The sandwiching piece 142 on the upper side is made by folding back a part of the wiring arrangement part 141 extending to an outer side of the sandwiching piece 143 on the lower side along the right-left direction of the vehicle 10. In the silencer 140, the sandwiching piece 142 may be located on a lower side of the sandwiching piece 143. Two sandwiching pieces 142 and 143 are fixed by a fixing member 70. The wiring member 30 is located on an outer side of the fixing member 70 in a width direction of the vehicle 10, and a connection part where two sandwiching pieces 142 and 143 are connected is located on an outer side of the wiring member 30.

Herein, the fixing member 70 is a clamp including a base part 71, a shaft part 72, and a locking part 73. However, the fixing member 70 is not limited to the clamp as long as it can fix two sandwiching pieces 142 and 143. For example, the fixing member 70 may be an adhesive agent, a rivet, or a tag pin-like member. The shaft part 72 connects the base part 71 and the locking part 73. The shaft part 72 passes through two sandwiching pieces 142 and 143. The base part 71 is located on an upper side of the sandwiching piece 142, and is caught on the sandwiching piece 142. The locking part 73 is located on a lower side of the sandwiching piece 143, and is caught on the sandwiching piece 143. When the silencer 140 in the wiring module 120 is disposed on the floor 11, the locking part 73 may be locked to the floor 11. That is to say, the fixing member 70 may double as a vehicle fixing member. The fixing member 70 may not be fixed to the vehicle 10. The vehicle fixing member may be or may not be provided separately from the fixing member 70.

A plurality of grooves may be provided to a surface of the wiring arrangement part 141 having contact with the wiring member 30. The plurality of grooves are provided at intervals along a route of the wiring member 30. Each of the plurality of grooves extends in a direction intersecting with an extension direction of the wiring member 30. A convex part is provided between two grooves, thus the convex part can function as a slip resistance of the wiring member 30.

The silencer 140 can be folded along a fold line 146 provided to the body part 144 in a state before being attached to the vehicle 10. The wiring module 120 is folded at the third portion 23, thus the second portion 22 located on the outer side of the silencer 140 can be surrounded by the folded silencer 140. Specifically, the second portion 22 located on the outer side of the silencer 140 is firstly folded at the third portion 23 between the first portion 21 and the second portion 22, and is located on the silencer 140. In this state, the silencer 140 is folded at the fold line 146 while the wiring member 30 is folded at the third portion 23 between two first portions 21 on the silencer 140, thus the second portion 22 is surrounded by the folded silencer 140. In the similar manner, herein, the third portion 23, the first portion 21C, and a backward portion thereof located on the outer side of the silencer 140 can also be surrounded by the folded silencer 140. The silencer 140 before being folded has too large a size to pass through the side opening parts 14A and 14B, and the silencer 140 after being folded has a size small enough to be able to pass through the side opening parts 14A and 14B. Accordingly, the wiring module 120 before being folded has too large a size to pass through the side opening parts 14A and 14B, and the folded wiring module 120 has a size small enough to be able to pass through the side opening parts 14A and 14B.

The fold line 146 is provided to extend in the right-left direction of the vehicle 10 in an intermediate part along the front-back direction of the vehicle 10, the third portion 23 is provided to a position of the fold line 146, and the first portion 21 is provided to each of the front side and the back side of the vehicle 10 across the fold line 146. A groove may be provided to a portion of the fold line 146. The groove extends along the fold line 146. The groove is provided to the portion of the fold line 146, thus the fold line 146 is easily recognized. The silencer 140 is easily folded at the fold line 146.

In the wiring module 120 according to the present embodiment, the wiring member 30 disposed on the left side of the vehicle 10 and the wiring member 30 disposed on the right side thereof are integrally formed via the silencer 140.

An effect similar to that of the wiring module 20 according to the embodiment 1 can be obtained also by such a wiring module 120.

The wiring module 120 includes the silencer 140 covering the floor 11 of the vehicle 10, and the silencer 140 includes the wiring arrangement part 141 in which the first section 33 is disposed to be the first rigid member 141 and the body part 144 continuously formed with the wiring arrangement part 141 and more flexible than the wiring arrangement part 141. Accordingly, the silencer 140 can supply rigidity to the first section 33 while the silencer 140 and the wiring member 30 are integrally formed.

The silencer 140 can be folded along the fold line 146 provided to the body part 144 in the state before being attached to the vehicle 10, and when the wiring module 120 is folded at the third portion 23, the second portion 22 located on the outer side of the silencer 140 can be surrounded by the folded silencer 140. The silencer 140 can be folded, thus the wiring module 120 is compactible, and can be easily put into the vehicle 10 from the side opening parts 14A and 14B for the side door or the rear opening part 15 in the vehicle 10. The portion located on the outer side of the silencer 140 is folded at the third portion 23, and can be surrounded by the folded silencer 140, thus it is suppressed that the wiring member 30 hangs down and is caught on a surrounding component when the wiring module 120 is transported, and the wiring module 120 is easily transported.

The fold line 146 is provided to extend in the right-left direction of the vehicle 10 in the intermediate part along the front-back direction of the vehicle 10, the third portion 23 is provided to the position of the fold line 146, and the first portion 21 is provided to each of the front side and the back side of the vehicle 10 across the fold line 146. Accordingly, the silencer 140 can be easily transported from the side opening parts 14A and 14B for the side door of the vehicle 10 so that the right-left direction of the silencer 140 coincides with the right-left direction of the vehicle 10. Accordingly, the silencer 140 after transportation can be easily positioned on the floor 11.

### Modification Example of Embodiment 2

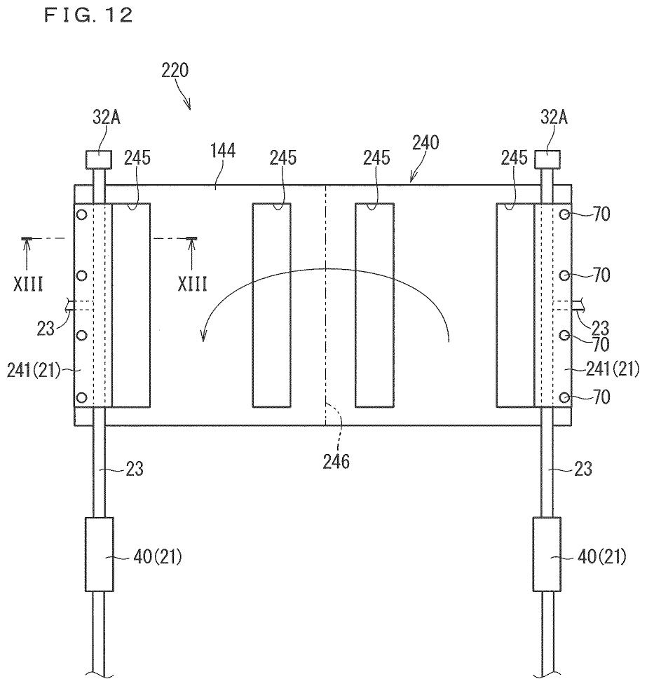

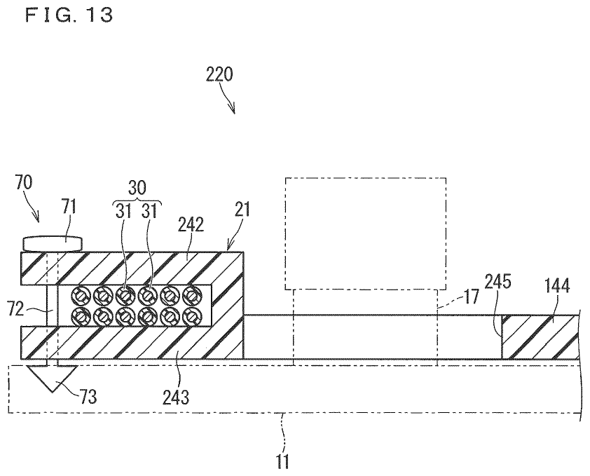

FIG. 12 is a plan view illustrating a modification example of the wiring module 120 according to an embodiment 2. FIG. 13 is a cross-sectional view along a XIII-XIII line in FIG. 12.

In a wiring module 220 illustrated in FIG. 12, a direction of a fold line 246 of a silencer 240 is different from the fold line 146 of the silencer 140 in the wiring module 120 described above. Specifically, the fold line 246 is provided to extend in the front-back direction of the vehicle 10 in the intermediate part along the right-left direction of the vehicle 10. Accordingly, the first portion 21 can be continuously provided easily without disconnection from the front end to the back end of the silencer 240 in the front-back direction of the vehicle 10.

The wiring arrangement part 241 as the first rigid member in the wiring module 220 also includes two sandwiching pieces 242 and 243 sandwiching the wiring member 30 in the up-down direction in the manner similar to the wiring arrangement part 141. In the wiring module 220, a way of providing two sandwiching pieces 242 and 243 is different from a way of providing two sandwiching pieces 142 and 143 in the wiring module 120. Specifically, the sandwiching piece 242 on the upper side is made by folding back a part of the silencer 240 located on an inner side of the sandwiching piece 243 on the lower side along the right-left direction of the vehicle 10. An elongated hole 245 which is long in the front-back direction of the vehicle 10 remains in a part of the silencer 240 remaining after the sandwiching piece 242 on the upper side is folded back. A slide rail 17 for a seat may be disposed in the elongated hole 245. Two sandwiching pieces 242 and 243 are also fixed by the fixing member 70. The wiring member 30 is located on an outer side of a connection part where two sandwiching pieces 242 and 243 are connected in the width direction of the vehicle 10, and the fixing member 70 is located on an outer side of the wiring member 30. The plurality of fixing members 70 are provided at intervals along the front-back direction of the vehicle 10. A part of the wiring member 30 branched from a part along the floor 11 toward the B pillar 13B extends from between the plurality of fixing members 70 toward the outer side of the silencer 240. In the silencer 240, the sandwiching piece 242 may be located on a lower side of the sandwiching piece 243.

### Appendix

In the description above, the first section 33 includes the section disposed on the floor 11 of the vehicle, the second section 34 includes the section disposed along the pillar 13 of the vehicle 10, and the third section 35 includes the section disposed along the wheel house 16 of the vehicle 10, however, this configuration is not necessary. The wiring member 30 may be provided in a position different from the floor 11 and a surrounding region thereof in the vehicle 10.

The configurations described in the embodiments and modification examples thereof can be appropriately combined as long as they are not contradictory.

### EXPLANATION OF REFERENCE SIGNS

10 vehicle
11 floor
12 roof
13 pillar
13A A pillar
13B B pillar
13C C pillar
14A, 14B side opening part
15 rear opening part
16 wheel house
17 slide rail
20, 120, 220 wiring module
21, 21A, 21B, 21C first portion
22, 22A, 22B second portion
23, 23A, 23B, 23C third portion
30 wiring member
31 wire-like transmission member
31a conductor core wire
31b covering
32, 32A connector
33, 33A, 33B, 33C first section
34, 34A, 34B second section
35, 35A, 35B, 35C third section
40 protector (first rigid member)
41 protector body
42 cover
50 sheet material (second rigid member)
60 adhesive tape
70 fixing member
71 base part
72 shaft part
73 locking part
140, 240 silencer
141, 241 wiring arrangement part (first rigid member)
142, 143, 242, 243 sandwiching piece
144 body part
146, 246 fold line
245 elongated hole

1. A wiring module, comprising:
a wiring member including a first section, a second section, and a third section as sections different from each other along an extension direction;
a first rigid member attached to the first section; and
a second rigid member attached to the second section, wherein
a portion including the first section and the first rigid member is a first portion,
a portion including the second section and the second rigid member is a second portion,
a portion including the third section is a third portion,
the first portion, the second portion, and the third portion are portions different from each other,
the third section includes a section located between the first section and the second section,
the third portion has bendability to be able to be folded,
rigidity of the first rigid member is larger than rigidity of the second rigid member, and
the second section is more bendable than the first portion, and is less bendable than the third portion.

2. The wiring module according to claim 1, wherein
the first section includes a section disposed on a floor of a vehicle,
the second section includes a section disposed along a pillar of the vehicle, and
the third section includes a section disposed along a wheel house of the vehicle.

3. The wiring module according to claim 2, further comprising
a silencer covering the floor of the vehicle, wherein
the silencer includes a wiring arrangement part in which the first section is disposed to be the first rigid member and a body part continuously formed with the wiring arrangement part and more flexible than the wiring arrangement part.

4. The wiring module according to claim 3, wherein
the silencer can be folded along a fold line provided to the body part before being attached to the vehicle, and
when the silencer is folded at the third portion, the second portion located on an outer side of the silencer can be surrounded by the silencer which has been folded.

5. The wiring module according to claim 4, wherein
the fold line is provided to extend in a right-left direction of the vehicle in an intermediate part along a front-back direction of the vehicle,
the third portion is provided in a position of the fold line, and
the first portion is provided to a front side and a back side of the vehicle across the fold line.

6. The wiring module according to claim 4, wherein
the fold line is provided to extend in a front-back direction of the vehicle in an intermediate part of the vehicle along a right-left direction.

7. The wiring module according to claim 1, wherein
the second rigid member is a sheet material made of resin.

8. The wiring module according to claim 1, wherein
the wiring member includes a plurality of wire-like transmission members,
the third portion includes an adhesive tape banding the plurality of wire-like transmission members, and
the second rigid member has higher rigidity than the adhesive tape.
